(19) United States
(12) Patent Application Publication
(10) Pub. No.: US 2006/0060085 A1
(43) Pub. Date: Mar. 23, 2006

(54) Composite filter media

(76) Inventors: Thaddeus J. Ptak, Ashville, OH (US); Eric W. Pontious, Circleville, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/232,600

(22) Filed: Sep. 22, 2005

Related U.S. Application Data
(60) Provisional application No. 60/612,397, filed on Sep. 22, 2004.

(51) Int. Cl. B01D 46/00

(52) U.S. Cl. 96/69; 55/486

(57) ABSTRACT

A composite filter media having excellent dust-releasing properties provided with a first layer of non-woven synthetic fibers having one outer surface hot calendered to increase smoothness and carrying a coating of a hydrophobic material which lowers surface tension and at least a second layer of non-woven synthetic fibers laminated to the downstream side of said first layer. A backing layer may be included to provide additional support to the first and second layer if desired. The second layer may include an electrostatic charge to increase filter efficiency at a reduced pressure drop across the composite media.

### CROSS-REFERENCES TO RELATED APPLICATIONS

This application claims the benefit of U.S. Provisional Application No. 60/612,397 filed Sep. 22, 2004.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to air filter media and particularly to a composite filter media with improved properties comprising a plurality of layers of non-woven synthetic fibers laminated to one another and to a method of making the same.

2. Description of the Related Art

Air filter media currently used today include layers of non-woven synthetic fibers, fiberglass and expanded microporous membranes, such as polytetrafluoroethylene (PTFE) or similar materials.

The expanded microporous membrane media possesses certain desirous characteristics for use as filter media, however, compared to types of paper media or synthetic non-woven fiber media, they are significantly more expensive.

In applications in which the filter media is intended to be regenerated by shaking and/or tapping the filter unit's holding frame against a solid surface, for example, the microporous membrane media are generally regarded as superior to other filter media currently used. The microporous membrane media possess a relatively smooth hydrophobic surface such that dust particles collected on the upstream surface of this media can be more easily removed upon shaking and/or tapping the filter against a solid surface.

Prior to the present invention, there has been essentially no alternative filter media which possesses characteristics sufficiently similar to those possessed by microporous membranes with regard to regeneration characteristics to provide an effective alternative in those filter applications wherein dust particle release properties are desirable or specified.

### BRIEF SUMMARY OF THE INVENTION

The present invention relates to a composite filter media comprising a laminate of a plurality of layers of non-woven synthetic fibers. The upstream layer comprises non-woven synthetic fibers which have been treated to enhance dust releasing properties. This treatment includes a coating of a hydrophobic material and a hot or cold calendering treatment of at least its upstream surface to provide a smooth surface. Both of these characteristics enhance dust release properties from this upstream surface such that regeneration of the filter efficiency is improved significantly.

In one preferred embodiment a second non-woven layer of synthetic fiber material is electrostatically charged to promote high efficiency filtration and is laminated to the downstream side of the first layer.

If desired, a third non-woven layer of synthetic fibers may be employed and laminated to the second layer. This third layer is selected to have properties of stiffness or strength to provide greater self-support of the composite laminate media formed and may be referred to as a backing layer.

The density of the first and second layer may be adjusted to modify the characteristics of the composite, including filter efficiency. In a preferred embodiment, the electrostatic charge applied to the second layer may also be employed to modify filter efficiency.

The media constructed according to the present invention may possess a wide range of filtration efficiencies including high efficiency filtration (HEPA) which is considered by those skilled in the art to meet the efficiency standard of 99.97 percent removal of 0.3 mm particles at an air face velocity of 10.5 ft/min to qualify.

Therefore it is an aspect of the present invention to provide a particulate filter media of a composite construction wherein two or more layers are laminated together to possess excellent filtration efficiency characteristics, low pressure drop and high regeneration capability.

It is another aspect of the present invention to provide a composite filter media of the type described which employs relatively low cost raw materials and can be economically manufactured compared to prior microporous membrane filter media having regeneration and similar filter efficiency properties.

### BRIEF DESCRIPTION OF THE SEVERAL VIEWS OF THE DRAWINGS

FIG. 1 is a schematic view of a preferred embodiment of the present invention illustrating a two-layer laminate construction.

FIG. 2 is a schematic view of another preferred embodiment of the present invention illustrating a three-layer laminate construction.

FIG. 3 is a graph comparing performance characteristics of a commercially available filter of the microporous type with a filter constructed in accordance with the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but may include connection through other elements where such connection is recognized as being equivalent by those skilled in the art.

### DETAILED DESCRIPTION OF THE INVENTION

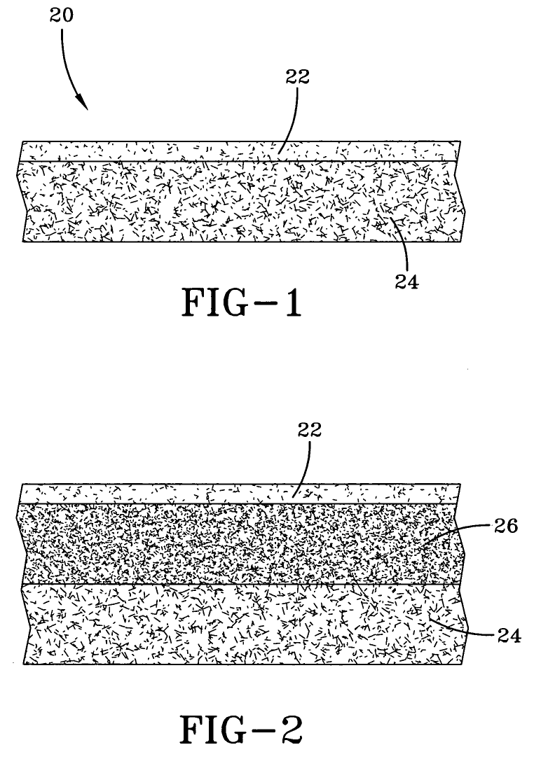

As best seen in FIG. 1 a composite filter media pad indicated generally at 20 and constructed in accordance with the present invention, is shown. The media pad 20 comprises a first layer 22 and a second layer 24 preferably laminated in overlying relationship to one another.

First layer 22 comprises a non-woven layer of synthetic fibers, preferably made by either meltblown or electrospinning processes and comprising fibers of polypropylene, polyester, or nylon for example. Layer 22 is treated with a coating of a hydrophobic material applied to at least one outer surface of layer 22 which is intended to face upstream. A preferred hydrophobic coating can be applied using conventional processes for well-known fluorochemical compounds, such as for example, polytetrafluoroethylene (PTFE). Such coating may be applied using a conventional plasma process and in conjunction with a smooth outer surface, lowers surface tension to enhance release of dust particles retained upon the upstream surface.

To provide a smooth outer surface to layer 22, at least one outer surface is subjected to a conventional hot or cold calendering process preferably prior to being coated with the hydrophobic material noted above. The temperature used in the hot calendering process may be between 200 to 250 degrees F. with sufficient pressure to obtain a satisfactory result with respect to smoothing the outer surface. The calendering process also reduces the thickness of layer 22. The smooth surface coated with the hydrophobic material of layer 22 faces the upstream or incoming air flow and significantly enhances the dust releasing properties of layer 22 as particulates retained on this upstream surface are relatively loosely adhered to this upstream surface. This increased dust releasing property provides for enhanced regeneration of the composite filter media after a period of use to restore the original or near original filtration efficiency at the original or near original designed pressure drop across the filter pad. This regeneration of filter effectiveness and desired pressure drop is possible because the first layer 22 is designed to trap the larger particle sizes on its upstream face. As these larger particles build up on the face of layer 22, the pressure drop increases. However, these larger particle sizes trapped on the surface of layer 22 are prevented from becoming trapped within layer 24 which without layer 22 would result in premature loading of layer 24 and a shorter useful life span. Since layer 24 is reserved for trapping the smaller particulates in the incoming air flow, regeneration as noted above enables the pad 20 to provide a longer useful life span compared to typical filter media not possessing similar composite construction and dust-release properties.

The layer 24 comprises a layer of melt-blown, non-woven synthetic fibers, such as polypropylene for example, which is preferably electrostatically charged so that higher efficiencies may be realized at lower pressure drops. The electrostatic charge may be applied using any suitable conventional and well-known process. Preferably layer 24 is conventionally cold calendered to reduce its thickness. For lower cost and lower efficiency performance, layer 25 need not be electrostatically charged, yet pad 20 still possesses the regeneration characteristics provided by the upstream layer 22 which offers a longer useful lifespan compared to prior art filters comprising non-woven fiber constructions.

The preferred density of non-woven layer 22 is between about 10 to 60 grams per square meter, and more preferably, between 20 to 50 grams per square meter. The preferred density of layer 24 may vary more widely depending upon the required efficiency of a particular filter application and the degree of electrostatic charge applied.

For example, the range of density of layer 24 preferably may be 20 to 80 grams per square meter generally, and more preferably 40 to 70 grams per square meter for high end and HEPA efficiency applications.

Depending upon the application requirements, a third layer 26 may be included in another embodiment of the composite media 25, such as shown in FIG. 2. Layer 26 comprises a layer of non-woven synthetic fibers, such as a spun-bond polyester or polypropylene. This layer of non-woven synthetic fibers is provided primarily to provide added support to render the composite media more self-supporting or more rigid when required, particularly in the preferred pleated form. Therefore it may have a preferred range in density between 80 to 200 grams per square meter, for example. Layer 26 may also be cold calendered to reduce its initial thickness. Layer 26 may be laminated between first layer 22 and second layer 24, however, it may more preferably be laminated to the downstream side of layer 24.

The permeability of the composite media pad 20 is preferably represented by a pressure drop of approximately between about 2.0 to 12 mm of water at an air face velocity of about 10.5 fpm. More preferred is a pressure drop of approximately about 2 to 10 mm of water at 10.5 fpm. The permeability is dependent upon the designed application which seeks the lowest pressure drop feasible for the efficiency required by the particular filtration application.

It is preferred that the total thickness of the composite media formed in accordance with the present invention be within the range of about 0.5 to 2.0 millimeters and more preferably about 0.5 to 1.0 millimeters. However, the final thickness may vary with the given requirements of a filter application.

The composite media filter pad formed in accordance with the present invention provides significant latitude in design of the final filter product for a wide range of applications and filtration efficiencies, yet provides very significant improvement in regeneration properties to restore the initial or near the initial efficiency rating and pressure drop comparable to the higher cost microporous type filters using PTFE or equivalent membranes. This regeneration feature provides the filter media a longer useful life which is desired in certain applications.

Further, the lower cost of raw material and manufacture of the composite media described herein provides the ability to competitively provide a filter for lower cost applications, such as vacuum cleaners or the like, which possess excellent regeneration characteristics and high efficiency to extend the useful life of the filter. Prior to the present invention, cost rendered the relatively short-lived, non-regenerable, conventional filter media the only commercially feasible choice for such lower cost applications.

It should also be noted that the composite media constructed in accordance with the present invention also provides a lower cost, equally effective filter for HEPA or near HEPA applications with similar regeneration characteristics as the most expensive porous membrane type filters.

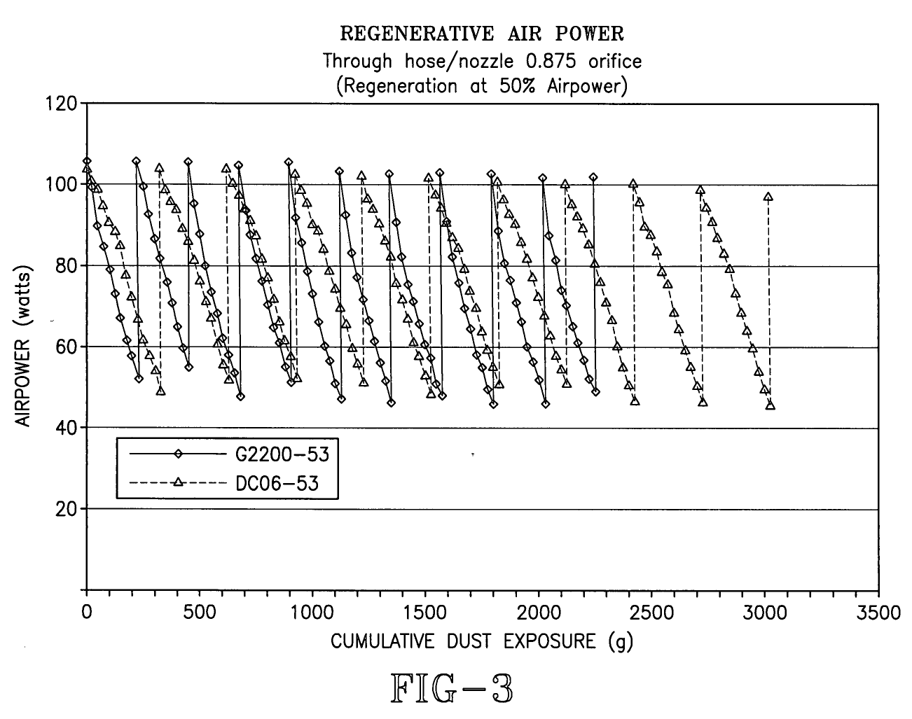

The following graph shown in FIG. 3 illustrates a comparison of regeneration characteristics of a filter comprising filter media constructed in accordance with the present invention and a commercial filter media comprising layers of expanded PTFE made by W. L. Gore and Associates, Inc., which was calendered and adhered to a backing layer for strength and support and is identified as G 2200-53.

The designation DC06-53 in FIG. 3 represents a sample of filter media constructed in accordance with the present invention consisting of a hot calendered fluro chemically treated layer of non-woven meltblown, polyester fibers, a layer of meltblown, non-woven and electrostatically charged polypropylene fibers and a spun bond layer of non-woven polyester fibers. The layers were conventionally laminated to one another. This sample was constructed under the below listed parameters.

Test Method

| Basis weight | TAPPI T410 | 240-280 | g/m² |
|---|---|---|---|
| Caliper | TAPPI T411 | 0.75-0.90 | mm |
| Permeability | TAPPI T251 | 12-20 | cfm/ft² |
| NaCl Penetration | TSI 8130 | <0.01% | |
| @10.5 fpm | | | |
| NaCl Penetration | TSI 8130 | <0.03% | |
| @60 lpm | | | |
| Pressure Drop | TSI 8130 | 7.5-11.5 | mm H₂O |
| @10.5 fpm | | | |

The DC06-53 and Gore sample were made with about 53 pleats per foot and both media were tested pursuant to ASTM Designation F 558-98 to measure air performance characteristics of vacuum cleaners. The same incremental amount of dust was added at nominally the same rate to the incoming air during each cycle which ended when the air power dropped to 50% of the original air power measured prior to the start of each cycle. Each filter media specimen was put through ten cycles with regeneration after each cycle accomplished by applying the same number of tapping type strikes applied to the filter frame holding the media using nominally the same force.

Based upon this test, the graph illustrates that the DC06-53 specimen constructed in accordance with the present invention was at least equal in regeneration capacity as the Gore sample media tested and maintained nearly 100% regeneration capacity for substantially nine of the ten cycles. Further, the DC06-53 filter media sample exhibited a longer exposure to a greater amount of dust loadings per cycle and a greater cumulative amount of dust loading over the ten cycles of the test compared to the Gore sample tested.

This example is particularly impressive when the cost of materials and labor to construct the DC06 filter media in accordance with the present invention is compared to the cost of the PTFE media layer available from W. L. Gore and Associates, Inc. Both filter media tested are applicable for high efficiency applications.

It should be understood that other filter media designs constructed in accordance with the present invention can also be advantageous employed in low end efficiency applications with the attendant advantage of excellent regeneration capabilities such that the filter media possesses a much greater useful life span via mere tapping and shaking the filter to remove the larger particles trapped on the upstream surface layer 22 exposed to the unfiltered incoming air stream. Such an advantage renders such a filter medium a highly effective, relatively low cost alternative to the essentially single use, throw away type filters presently used in many such applications.

The specifications for a preferred low end efficiency filter application constructed in accordance with the present invention is as follows:

Test Method

| | | | |
|---|---|---|---|
| Basis weight | TAPPI T410 | 220-270 | g/m² |
| Caliper | TAPPI T411 | <0.7 | mm |
| Permeability | TAPPI T251 | 45-80 | cfm/ft² |
| Pressure Drop | TSI 8130 | 1.5-3.3 | mm H₂O |
| @10.5 fpm | | | |

| | | |
|---|---|---|
| NaCl Penetration | TSI 8130 | <50% |
| @10.5 fpm | | |

It should be noted that the degree of electrostatic charge applied to layer 24 preferably controlled to provide the level of filter efficiency desired as the more preferred manner to control efficiency versus pressure drop through the filter. However, for relatively low end efficiency applications, one may choose to employ a conventional layer 24 of non-woven fiber construction without applying an electrostatic charge and still retain the dust-releasing capacity provided by layer 22 to improve useful life in accordance with the present invention.

While certain preferred embodiments of the present invention have been disclosed in detail, it is to be understood that various modifications may be adopted without departing from the spirit of the invention or scope of the following claims.

1. A composite filter media comprising, in combination:
a) a first filter layer formed of non-woven synthetic fibers, including an upstream and downstream surface, said upstream surface being smoothed by calendering and coated with a hydrophobic material;
b) a second layer formed of non-woven synthetic fibers laminated to the downstream surface of said first layer; and
c) the composite layer formed by said first and second layers having a final thickness in the range of about 0.5 to 2.0 mm and exhibiting a pressure drop of between about 2.0 to 11.5 mm of water at an air face velocity of 10.5 fpm.

2. The composite filter media defined in claim 1 wherein said first filter layer has a density of between about 5 to 40 grams per square meter.

3. The composite filter media defined in claim 1 wherein said second layer has a density of between about 5 to 80 grams per square meter and carries an electrostatic charge for increasing filter efficiency.

4. The composite filter media defined in claim 1 wherein said first layer comprises melt-blown synthetic fibers taken from the group consisting of polypropylene, polyester, nylon or a combination of two or more thereof.

5. The composite filter media defined in claim 1 wherein said second layer comprises melt-blown synthetic fibers taken from the group consisting of polypropylene, polyester, nylon or a combination of two or more thereof.

6. The composite filter media defined in claim 1 including a third layer of non-woven synthetic fibers laminated downstream to at least one of said first and second layers.

7. The composite filter media defined in claim 6 wherein said third layer has a density of about 70 to 200 grams per square meter.
